(19) United States
(12) Patent Application Publication
(10) Pub. No.: US 2015/0154716 A1
(43) Pub. Date: Jun. 4, 2015

(54) SPONSORED WIRELESS DATA TRANSMISSION FOR CUSTOMERS

(71) Applicant: Liberty Mutual Insurance Company, Boston, MA (US)

(72) Inventors: Jane Ann Ford, Boston, MA (US); Vincent Thomas Kasabian, Boston, MA (US); Michael Wesley Klein, Boston, MA (US); Russell Bernard Coit, Boston, MA (US); Mary Ellen Morse, Boston, MA (US)

(21) Appl. No.: 14/622,248

(22) Filed: Feb. 13, 2015

Related U.S. Application Data
(60) Provisional application No. 61/986,708, filed on Apr. 30, 2014.

(51) Int. Cl. G06Q 40/08

(52) U.S. Cl. CPC G06Q 40/08

(57) ABSTRACT

Processes are engineered to electronically identify different types of mobile data so as to facilitate an insurer to pay wireless data transmission costs for customers who transmit specific types of information to the insurer.

### CROSS-REFERENCE TO RELATED APPLICATION

This application claims the benefit of U.S. Provisional Application No. 61/986708, filed Apr. 30, 2014, which is incorporated herein by reference.

### TECHNICAL FIELD

The present subject matter is generally related to mobile computing, and more particularly, it relates to electronically differentiating different types of mobile data for expense burden purposes.

### BACKGROUND

At the end of 2012, there were roughly 1.5 billion mobile broadband subscriptions, growing at a 50% year-on-year rate. Mobile broadband subscriptions are expected to reach 6.5 billion in 2018. “Mobile broadband” is the term for wireless Internet access through a mobile phone, tablet, or other mobile devices. Mobile data traffic doubled between the end of 2011 (620 petabytes in 2011) and the end of 2012 (1280 petabytes in 2012). This traffic growth is likely to be driven by large increases in the number of smartphones being sold, the use of more demanding applications, and in particular, video and the availability and deployment of newer 3G and 4G technologies capable of higher data rates. By 2018, total mobile broadband traffic is expected to increase by a factor of 12 to roughly 13,000 petabytes. Many policyholders and claimants have mobile devices for personal data consumption. These customers are bearing the financial responsibility of accessing or sending customer content to an insurance carrier on their personal data plans. This is a problem as it inhibits the customer from properly and efficiently managing their account. In turn, this can have an effect on the insurance company in terms of effectively servicing the policyholders.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1-2 are pictorial diagrams.

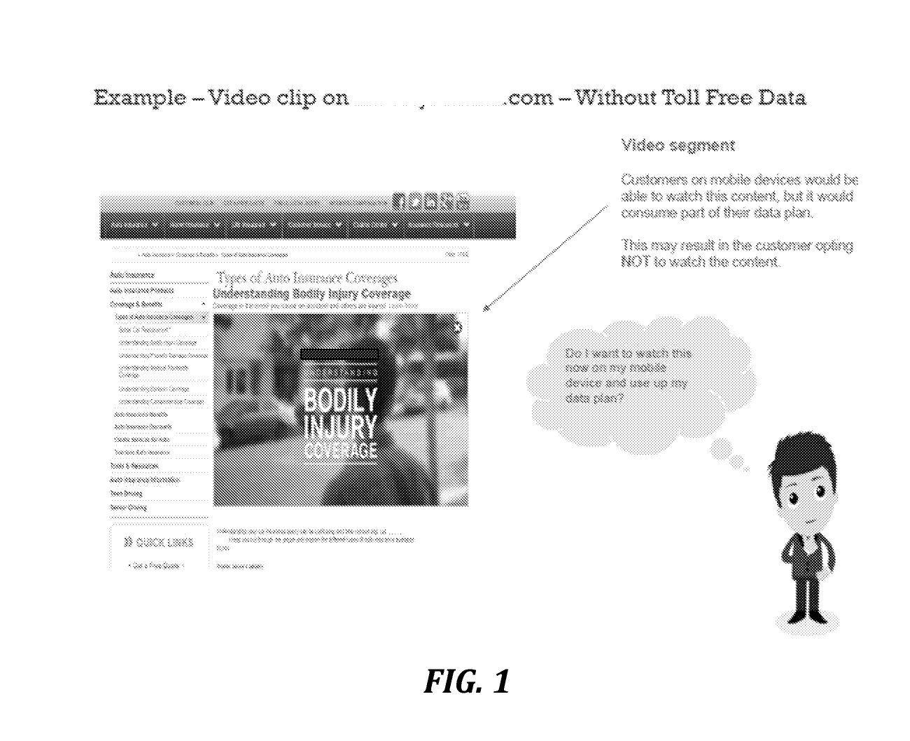

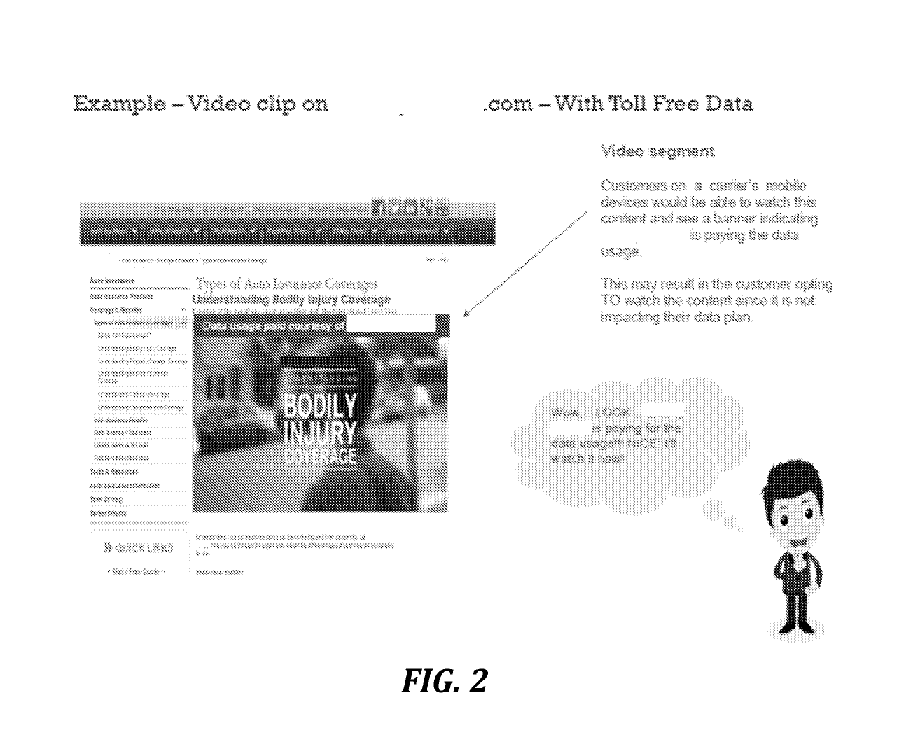

### DETAILED DESCRIPTION

Various embodiments are engineered to electronically differentiate different types of mobile data so as to facilitate an insurer to pay wireless data transmission costs for customers who transmit or receive specific types of information to and from the insurer. For example, the types of mobile data that can be expensed include photographs and/or descriptions of household belongings to facilitate future claims processing; photographs of damage to insured properties such as autos, boats, and homes to facilitate claims processing; transmission of telematics data for the purpose of fine-tuning the underwriting profile of the insured; eliminating or minimizing loss by gathering and triggering an early response to environmental data that indicates escalating risk exposure; and so on.

Various embodiments are engineered to reduce or eliminate reluctance of customers to provide information needed or desired by an insurer for business purposes. By differentiating different types of mobile data, the insurer's assumption of cost happens transparently with no action required on the part of the customer. By leveraging wireless carrier-sponsored data Application Program Interfaces (APIs), various embodiments tag targeted data to identify it as insurer's payable data. The tagged data will be the mechanism used to distinguish the insurer's payable data from customer-liable data in the customer's ongoing data transmission stream.

While the embodiments of the invention have been illustrated and described, it will be appreciated that various changes can be made therein without departing from the spirit and scope of the invention.

The embodiments of the invention in which an exclusive property or privilege is claimed are defined as follows:

1. A system with hardware structures as substantially illustrated and described.

2. A method as substantially illustrated and described.

3. A computer-readable medium as substantially illustrated and described.
